(19) United States
(12) Patent Application Publication
(10) Pub. No.: US 2005/0149423 A1
(43) Pub. Date: Jul. 7, 2005

(54) Option value indicator

(76) Inventors: Stephen J. Roseme, Allentown, PA (US); Adrian K. Roberts JR., Grants Pass, OR (US)

Correspondence Address: BLACK LOWE & GRAHAM, PLLC, 701 FIFTH AVENUE, SUITE 4800, SEATTLE, WA, 98104, US

(21) Appl. No.: 11/012,921

(22) Filed: Dec. 15, 2004

Related U.S. Application Data
(60) Provisional application No. 60/530,007, filed on Dec. 15, 2003.
(60) Provisional application No. 60/548,479, filed on Feb. 27, 2004.

(51) Int. Cl. G06F 17/60

(52) U.S. Cl. 705/36; 705/35

(57) ABSTRACT

A method for computing a value factor of at-least-one option contract having a market, an expiration date, a price of an underlying contract on a current date, and a strike price. The method includes calculating a theoretical return based upon the expiration date, the strike price, the price of the underlying contract on the current date, and a risk-free interest rate on the current date. Targeting a yield (z) is based upon the price of the underlying contract and a designated multiple of the theoretical return of the at-least-one option contract. Calculating the value factor is based upon the yield (z), an underlying contract price, and the expiration date.

### PRIORITY CLAIM

This application claims priority from two provisional filings, both entitled “ANALYTICAL VALUE INDICATOR” the first of these filed Dec. 15, 2003 and receiving Ser. No. 60/530,007 and the second being filed on Feb. 27, 2004 and receiving Ser. No. 60/548,479. This application incorporates both applications by reference.

### BACKGROUND OF THE INVENTION

In a global economy, having a continuous cycle of change and instability, markets cannot immediately adjust to such influences as supply or demand, therefore they trend over time. Because trending takes place over periods, observed price trends can be exploited over time through a systematic, diversified approach to options investment.

Markets go through periods of equilibrium with few opportunities arising. Where there are no significant changes in the markets, the performance of stable markets yields less of a return on investment than money in a risk-free investment. Spotting price trending in the market is difficult given the great diversity of commodities markets and the numerous contracts available in each of the markets. Additionally, since individual markets spend a relatively small percentage of time trending, the process of determining markets that are suitably trending requires a number of calculations in order to discern which of a minority of markets are trending.

Fundamental analysis is based on the study of external factors that affect the supply and demand of a particular commodity in order to predict future prices. Such factors may include anything from economic and trade policies of various governments to weather and current crop conditions of the major agricultural commodities. Fundamental analysis theorizes that by monitoring the relevant supply and demand factors of a particular commodity, a potential lack of equilibrium of the market may be identified, causing price levels to shift.

Technical analysis is based on the theory that the study of commodity prices themselves provide a means of anticipating the external factors that affect the supply and demand of a particular commodity. Technical analysis theorizes that commodity prices reflect all known factors affecting supply and demand at any given time. By studying the detailed analysis of daily, weekly and monthly price fluctuations, as well as changes in volume and open interest of a commodity market, a prediction can be made of the future price movement.

In 1969, Fischer Black and Myron Scholes developed the Black-Scholes Option Pricing Model. The original form of the Black-Scholes Model was intended to evaluate European options on non-dividend paying stocks. In 1976, Fischer Black made slight modifications to the model to allow for the evaluation of options on futures contracts. In 1983, Market Garman and Steven Kohlhagen made several other modifications to allow for the evaluation of options on foreign currencies. The futures version and the foreign currency version are known officially as the Black-Scholes Model and the Garman-Kohlhagen Model, respectively. But the evaluation method in each version, whether the original Black-Scholes Model for stock options, the Black-Scholes Model for futures options, or the Garman-Kohlhagen Model for foreign currency options, is so similar that they have all come to be known simply as the Black-Scholes Model.

While the Black-Scholes Model has become a standard analytical tool for pricing options, it cannot, by itself answer questions directed at which options are more likely to return a particular yield than another without a great many successive iterations for each of the option contracts under analysis. Even at that, pricing is not the sole analysis that is useful when an investor is trying to predict when an option contract will be “in the money.” With the proliferation of the options market, it has become increasingly difficult and time consuming for traders to sift through massive option data to locate an option that matches specific budgeting or a designated time criteria.

Where investors target an option based upon a fundamental analysis of the factors affecting a market or a technical analysis by observing trending in a market, the options the investor felt were likely to exploit the predicted movement in the market were already identified. Once these options were targeted another calculation is made in order to decide which option appeared to offer the best “value”. Such calculations are very time consuming and very cumbersome.

The amount of analysis necessary by known means taxes the computational resources of professional traders, and made more apparent by the need to do so on a daily basis; a similar analysis would be nearly impossible for the individual investor. The onerous burden of calculation ultimately forces the investor to pick options based upon generalized impressions of the market thereby failing to capitalize on best opportunity and possibly to hamper the investor's performance in the market.

There is an unmet need in the art for an efficient method to sort through a massive options database in order to find an option that met the criteria specified by each trader. Once these options are targeted there exists a further unmet need for assessing which option appeared to offer the best “value”.

### SUMMARY OF THE INVENTION

A method for computing a value factor of at-least-one option contract having a market, an expiration date, a price of an underlying contract on a current date, and a strike price. The method includes calculating a theoretical return based upon the expiration date, the strike price, the price of the underlying contract on the current date, and a risk-free interest rate on the current date. Targeting a yield (z) is based upon the price of the underlying contract and a designated multiple of the theoretical return of the at-least-one option contract. Calculating the value factor is based upon the yield (z), an underlying contract price, and the expiration date.

An embodiment of the instant invention comprises a tool used to determine the probability of a long-option position achieving profitability between the date the option is purchased and the date that the option expires. The analysis exploits aspects of the Black-Scholes Model while using assumptions that are calculated to drive down the iterative computational overhead.

The analysis also includes other probabilistic tools to derive a value factor indicative of an option contract investment returning a designatable return, in one embodiment an additional 100% of premium. Having designated, for example, a return of 100% of the premium or essentially doubling the money placed at risk, a probability distribution allows an index to be created in order to express the appropriate probability of receiving the desired return. Such a preferred embodiment will express the index for a doubling of the money as a probability according to the choice of puts and calls. In the case of calls, the designated probability expresses the probability of a price for the commodity exceeding the strike price added to twice the premium. For puts, the probability expresses the probability of the price dropping below the strike by at least twice the premium.

A further embodiment of the present invention places an active webpage on the Internet; the active page presents, prioritizes, and ranks each of the available contracts, in one case 42 major commodity markets, according to user designated choices of calls or puts, budget, and a period of trading in which the contract will achieve the designated return. Additionally, the active webpage will inform the inventor of a theta value for each of the contracts where the theta exceeds a designated threshold. By ranking according to probability of achieving a designated return and warning of a more rapid decay of value, the embodiment of the invention provides the trader with indicia of option contracts that are likely to produce returns without the extensive and rigorous analysis that would normally accompany such a decision.

A further embodiment of the invention provides a computationally efficient method to sort through a massive options database in order to find an option-meeting return criteria specified by each trader. Because the value factor can be derived for an option contract without knowing the investor's particular designations of a direction, budget, and particular time horizon, the calculations can be performed as returns are available and then sorted in response to an investor's designations and the magnitude of the value factor.

In a further embodiment of the invention, a theta warning system is implemented to warn the investor of the effects of the time value of money. Theta is a term defined as the percentage of the underlying option's premium eroding each day because of time passing by as money otherwise invested could be returning a designated risk-free rate of return. As theta approaches a designated value, warnings appropriate to the proximity to the designated value for theta are issued to inform a trader that value is eroding from the option contract. Thus, the trader may chose to change a position based upon that high theta.

As will be readily appreciated from the foregoing summary, the invention provides a comprehensive, robust, and economically based means of evaluating option probabilities in a selected market.

### BRIEF DESCRIPTION OF THE DRAWINGS

The preferred and alternative embodiments of the present invention are described in detail below with reference to the following drawings:

FIG. 1 is a flowchart setting forth the method of evaluating contracts in a selected market;

FIG. 2 is a page stored on a network to facilitate a user choice of a market for evaluation;

FIG. 3 is a page stored on a network to facilitate a user choice of direction, budget, and time horizon for suitable option contracts;

FIG. 4 is a page stored on a network reporting contracts in the selected market sorted according to a value factor and indicative a high theta factors;

FIG. 5 is a first spreadsheet segment of a computer software component of a presently preferred embodiment;

FIG. 6 is a second spreadsheet segment of a computer software component of a presently preferred embodiment;

FIG. 7 is a third spreadsheet segment of a computer software component of a presently preferred embodiment;

FIG. 8 is a fourth spreadsheet segment of a computer software component of a presently preferred embodiment;

FIG. 9 is a fifth spreadsheet segment of a computer software component of a presently preferred embodiment; and

FIG. 10 is a sixth spreadsheet segment of a computer software component of a presently preferred embodiment.

### DETAILED DESCRIPTION OF THE PREFERRED EMBODIMENT

Option trading is particularly difficult because it requires the trader to not only pick the correct the direction of market movement, but also the correct time horizon. In addition, long-option positions have theta (or time decay) constantly absorbing their option premium. To date, investors have used either of a fundamental or technical approach for predicting the movement of a market. By either means or by a combination thereof, an investor will select markets the investor believes to be likely to move and thus allow trading to exploit that movement.

Once the investor selects the market direction of that movement in that market to be exploited either as a put or a call option, the investor's circumstances or perceived needs will as likely indicate a budget and a time horizon for the investment. While an embodiment of the invention will further refine and inform the investor's selections of these variables, the presently preferred embodiment of the invention allows an investor to select a market, a market direction, a budget and a time horizon.

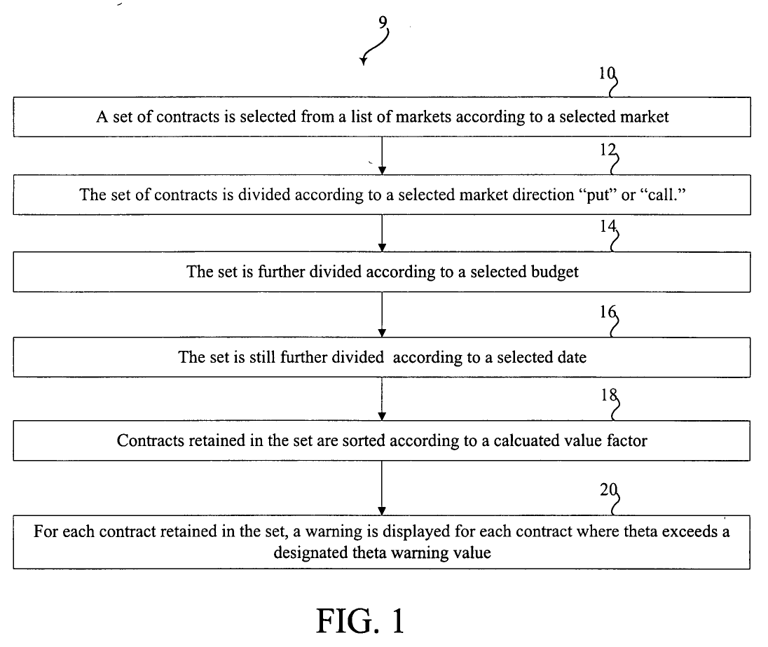

Referring to FIG. 1, a flowchart 9 setting forth the method of evaluating contracts in a selected market commences with selecting a market from a list of markets for which most recent pricing data is available and compiled. At a block 10, the investor selects a market the investor believes will experience sufficient price movement as to allow exploiting that movement for a greater return on investment. In a presently preferred embodiment, the markets chosen are those commonly traded and reported in such pits as the Chicago Board of trade, but the only limitation on the markets is that the markets must be such as to have sufficient pricing information on contracts available so as to work out a suitable price history for trending.

In a particular market, the investor chooses a direction the investor believes the market will move and designates that direction as either a put or a call. The investor's designation of put or call eliminates from the considered group of contracts all of those that are not suitably either a put or call according the investor's choice. By this elimination of non-conforming contracts, the volume of information presented to the investor is diminished according to the investor's expressed selections.

At a block 14, the investor's selection of a budget further culls the contracts to produce only those contracts that fall within the investor's budget. Budgetary considerations in options trading emphasize a major difference between option contracts and more granular investment instruments such as stocks or bonds.

At a block 16, the investor selects a time horizon for the investment. Time horizon is distinct from expiry dates in that a particular contract may arrive “in the money” before the date of delivery specified in the contract. Thus, if for reasons of demand, a spot price of a contract begins to trend upwards and continues to do so even though it is months away from the expiry date, the contract would have suitably fulfilled the investor's designation that it return a multiple of its premium within a designated time horizon so long as the rise occurred before the end of the time horizon.

At a block 18, the contracts remaining, after the culling at each of the blocks 10, 12, 14, and 16, are sorted according to a value factor. The value factor is an index based upon the probability of a contract price moving in the designated direction by a multiple of the premium. The value factor is based upon the recent price of the option contract and then projecting forward a probability based upon a normal probability distribution.

Two values are necessary to meaningfully evaluate either a call or a put, thus:
C=theoretical value of a call (1)
P=theoretical value of a put (2)

In the most general terms, an opportunity to realize a profit on either a put or a call comes from a divergence between the sum of the exercise or strike price and the price of the underlying contract. One must make more than money out of pocket to realize a profit. To determine a price of an action on an option, variables are assigned to the money necessary to purchase the option known as an exercise or strike price, and the price to purchase the underlying contract according to the option's terms, thus:
U=price of the underlying contract (3)
E=exercise (strike) price (4)

The present value of a sum of money to be paid in the future is rarely the same as the certain value of the funds on the date of payment. In simple terms, placing a sum of money in a risk free investment such as a treasury bill will yield a sum certain to purchase the underlying contract according to the terms of the option. In economics, a formula for determining the amount of money held in a risk free investment for a fixed period prior to maturity in order to yield the price of the underlying contract is expressed as:
Ue^{-rt} (5)
where:
t=time to expiration expressed in years (6)
r=risk free interest rate expressed in decimal form (7)
e=base of the natural logarithm, approximately equal to 2.71828 (8)

A present value for an exercise price may similarly be expressed as a product of the exercise price times e^{-rt} to reflect the value of the funds in the amount of the exercise price invested in the risk-free investment over time. The term is used to normalize results according to the time value of the money invested in the option and is included in the evaluation of the option as an investment.

The theoretical value of the put and the call options should be further corrected to reflect variability of a spot value of the underlying contract asset. A normalized distribution of a variable h₁expressed as N(h₁) and a further normalized distribution of a variable h₂, N(h₂), affords a tool to allow a further correction of the risk of the option being exercised.

$$\begin{matrix}{h}_{1} = ( \frac{ln ( \frac{U}{E} ) + ( {v}^{2} / 2 ) T}{v \sqrt{t}} ) & ( 9 ) \\ {h}_{2} = {h}_{1} - v \sqrt{t} & ( 10 )\end{matrix}$$

where v=annual volatility such that v² is the variance of the price of the underlying contract expressed on an annual basis and v is the standard deviation of that price expressed in decimal form (11)
and where ln=natural logarithm, ln(e^{x})=x, for all real x. (12)

To express the further corrected theoretical value of the call or put options, the probabilities of the call or put respectively are multiplied with the present value of the underlying contract price and the exercise price. Discounting each of the values of the underlying contract purchase price and the exercise price according to the probability of the respective occurrences yields:
C=Ue^{-rt}N(h₁)−Ee^{-rt}N(h₂) (13)
P=Ee^{rt}N(−h₂)−Ue^{-rt}N(−h₁) (14)

Given the theoretical values of the call (Equation 13) and the put (Equation 14) respectively, an index of probable performance or value-factor can be suitably configured to express the probability that the price will move further than a product of the premium and a designated factor selected to reflect a given level of performance of the option. While the presently preferred embodiment employs a factor of one, meaning that the investment will return once again the value of the premium. Such a value factor may be expressed as:

$$\begin{matrix}{VF}_{Call} = 10 \times ( ( 1 - N ( q ) ) ) & ( 15 ) \\ {VF}_{Put} = 10 \times ( ( 1 - ( 1 - N ( q ) ) ) ) & ( 16 ) \\ where q = \frac{ln ( \frac{z}{U} )}{v \sqrt{t}} & ( 17 ) \\ and where {z}_{Call} = E + 2 C & ( 18 ) \\ and where {z}_{Put} = E - 2 P & ( 19 )\end{matrix}$$

The value factor, as taught in this presently preferred embodiment, is an adjusted probability achieving a value for a return of z for either a put or a call, therefore, as taught herein, the value factor is based upon doubling one's money, as set forth above, given the markets current theoretical implied volatility.

Calculating the value factor begins by calculating the probability of doubling one's money by expiration of a given option. For a put, the doubling of one's money occurs when the price at expiration is less than the exercise price by two times the theoretical price of the option. For a call, the achieved price z must exceed the call by two times the theoretical call price. These relationships are set forth in Equations 19 and 18 respectively.

Using the suitable z-value, a q-value is derived. The ratio between z and the price of the underlying contract gives a scale to the value of z with respect to the underlying contract. Through an objective calculation for implied volatility, a distribution of price levels is generated. The distribution represents the possible price movements between the date the option was purchased and its expiration. Prices are assumed to be lognormally distributed about the price of the underlying contract. Recognizing the lognormal distribution, the natural log of the ratio is taken to ascertain a probability of each price. The resulting natural log is then normalized against the product of the volatility multiplied by the square root of the units of time to yield a factor “q.”

Imposing the normalized or Gaussian probability distribution on the resulting factor q, yields a likelihood or probability of achieving the doubled return in the presently preferred embodiment. By rating options according to the adjusted probability of profit, the embodiment of the invention allows traders to search for options that have the highest likelihood of achieving a profit. As one can appreciate, using probability of profit rather than valuation algorithms is significantly different from the traditional use of the Black-Scholes equation solely to find over- or under-valued options.

The normalized function calculated at the q-value is then subtracted from unity to yield an appropriate probability to suitably predict the call probability. The put probability being the inverse of the call probability, that call probability is subtracted from unity again to yield the call probability.

Once a value factor is suitably derived for, at least, each of a plurality of contracts remaining in the set of contracts after the operations of the blocks 10 through 16, the contracts are readily sorted according to the magnitude of the value factor at the block 18. In the presently preferred embodiment, the list is also re-sortable according to any of several reported attributes of the selected contract such as volume traded the previous day or premium.

At a block 20, a warning is generated where a modified theta value for the contract is calculated to exceed a designated threshold in the presently preferred embodiment. Time decay is the description of the diminution of value of the investment when compared to the risk-free investment discussed above. Theta is a measure of the effect of a change in time to expiration on the theoretical values of puts and calls. Theta is sometimes referred to as the time decay factor because it measures the rate at which an option loses its value as time passes. The theta of an at-the-money option always increases as expiration approaches, so a short-term at-the-money option will always decay more quickly than a long-term at-the-money option. Theta indicates an absolute change in the option value for a ‘one unit’ reduction in time to expiration.

The effect of time on the option price is almost always positive given the American system where the option may be exercised whenever the conditions are favorable. The more time until expiration the better chance the option has of being in-the-money at expiration. The only exception to this positive relationship is deep in-the-money put options with an expiration date far into the future. An “at-the-money” option always has a greater theta than either an “in-the-money” or an “out-of-the-money” option with the same expiration date. All other things being equal, options with low thetas are more preferable for purchase than are those with high thetas.

Intuitively, it makes sense that for each time unit, or year in this case, a value of extending a duration of the option by a single time unit is approximated by multiplying the theoretical value of either the put or the call by the inverse of the interest rate for the same time unit. To better approximate a lost value, however, an addition is made to approximate the cumulative effect on value experience while waiting for an opportunity to exercise the option at optimum conditions. Based on a price of the underlying contract, a normalizing factor, the cumulative normal density function (the area under N(x)), is multiplied by the price of the underlying contract to yield the additional value of being able to wait for optimum conditions for exercising the option.

Thus, to determine theta, the inventive process calculates theta for each of the put or the call options thus:

$$\begin{matrix}{θ}_{call} = - rU {ⅇ}^{- rt} N ( {h}_{1} ) + rE {ⅇ}^{- rt} N ( {h}_{2} ) + \frac{U {ⅇ}^{- rt} {N}^{′} ( {h}_{1} )}{2 \sqrt{t}} & ( 20 ) \\ {θ}_{put} = rU {ⅇ}^{- rt} N ( - {h}_{1} ) - rE {ⅇ}^{- rt} N ( - {h}_{2} ) + \frac{U {ⅇ}^{- rt} {N}^{′} ( {h}_{1} )}{2 \sqrt{t}} & ( 21 )\end{matrix}$$

To suitably exploit the theta value a scaling factor is used to implement a warning system. The warning system highlights options that are experiencing rapid time decay and differs from a traditional Black-Scholes Model by normalizing theta to reflect a daily decay value, and dividing this adjusted theta value into the current premium. If the resultant value exceeds 1.5% in the presently preferred embodiment, a legend describing the option is highlighted in red to indicate a rapid acceleration in time decay.

The method described here may optionally include additional steps of selecting a contract for monitoring, or for inclusion in a portfolio of contracts reflecting purchased contracts. In an integrated method, the analysis might indicate suitable options for investment according to the investor's designated criteria and further allow the execution of instructions to purchase the option contract the investor selects according to ranking by the value factor.

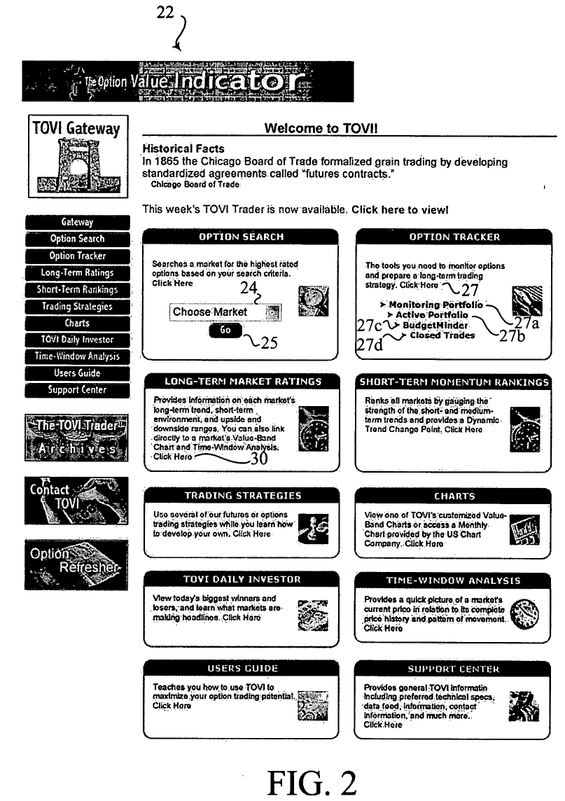

FIG. 2 is a page 22 stored on a network to facilitate a user choice of a market for evaluation exploiting the presently preferred embodiment set forth in the flowchart 9. A drop-down window 24 allows an investor to select a relevant market from among the several markets in which option contracts are sold. To narrow the information presented to the investor to make meaningful the selections of contracts, the investor is allowed to select a market first in the presently preferred embodiment.

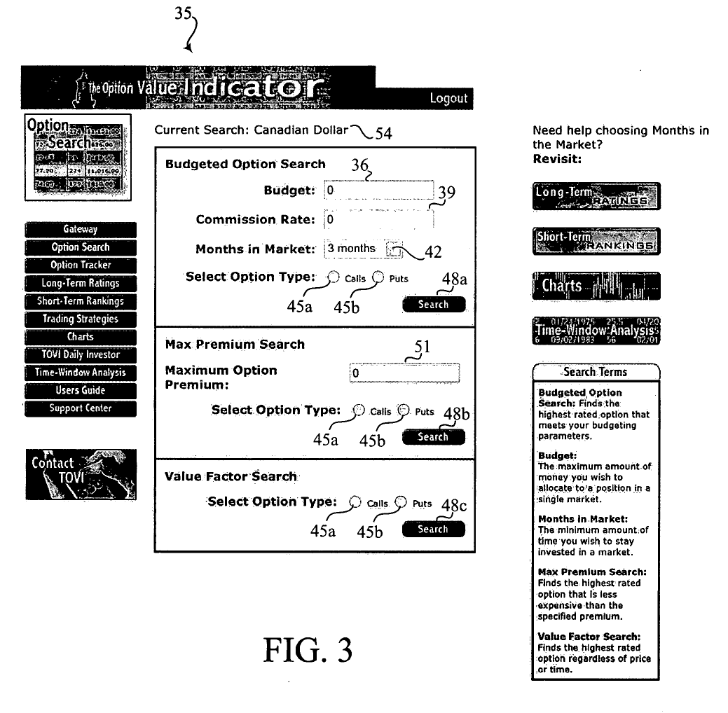

Because the markets for which suitable historical data is compiled are known to the designer of the page 22, a data-entry convention known as a drop-down window 24 includes a list of markets available for analysis. Working in concert with the drop-down window 24, a “go” button 25 executes the script to direct the browser to an option search page 35 (FIG. 3) devoted to searching the market designated in the drop-down window 24 when the “go” button 25 is activated.

The page 22 is optionally configured to allow for navigation to several distinct pages of a website, none of the distinct pages being necessary in the preferred embodiment of the invention. Most closely related to the invention, while not necessary for its utility, are other active buttons 27, 27a, 27b, 27c, and 27d configured to direct a user to a number of data reporting options associated with the user.

A first active button 27 redirects a web browser to an option tracker landing page configured to inform a user of strategies suitably employed to exploit the inventive method. Additionally, it may include information relating to the use of pages configured to exploit data reporting according to option designations stored in association with the user.

A second active button 27a is configured to redirect a browser to a monitoring portfolio page that is configured to display a user-selected group of options and displaying suitable information relating to contracts that a user may designate for monitoring. The term monitoring is used to express an observing of both reported attributes and calculated factors such as the value factor or, optionally, traditional Black-Scholes factors such as gamma, rho, and delta for each option contract.

A third active button 27b redirects the browser to an active portfolio page distinct from the monitoring page in that it reflects the similar information for those currently active trades that user is currently holding. Generally, as to the contracts for which information is set forth at the active portfolio page, the user has designated such contracts as active in order to keep track of the user's current positions in various markets. In one embodiment, the user places contracts in the active portfolio by executing a buy order for that contract.

A fourth active service button 30 directs the browser to a BudgetMinder active service page configured to allow a user to determine the amounts ascribed to each option or market amounts at risk. The BudgetMinder page enables a user to watch each of the several put or a call contracts in the aggregate in order to track when, due to movement of each of the puts or calls currently active on the active portfolio page, the amounts at risk meet or exceed a designated aggregate budget for trading.

Finally, a fifth active button 27d, maintains a portfolio of closed trades. These are trades that together constitute a trading history for evaluating an effectiveness of trading strategies employed by the user. Within the page, portfolios may optionally be designated to give more defined comparison of either strategies or markets that the user has employed for investment.

As indicated in the discussion of the flowchart 9, a user deciding that reasons exist for movement in the market will generally have determined a direction for that movement and a likely time for that movement to reach a trading opportunity. These user selectable criteria are entered in order to allow a sorting of contracts according to the criteria. To enable a search based upon these user selectable criteria, a data-entry page is used to inform an options search.

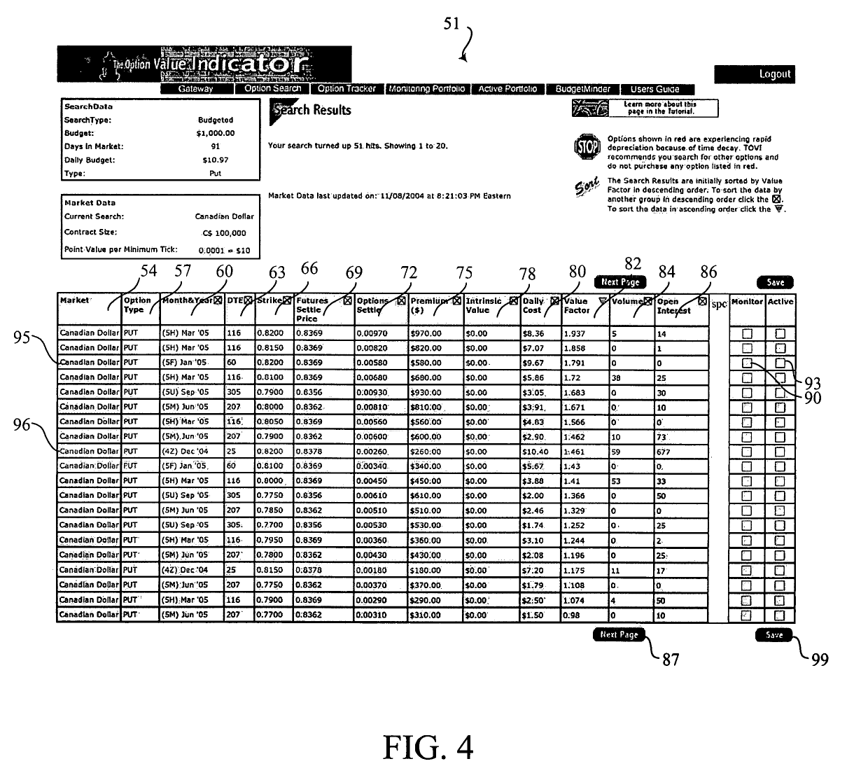

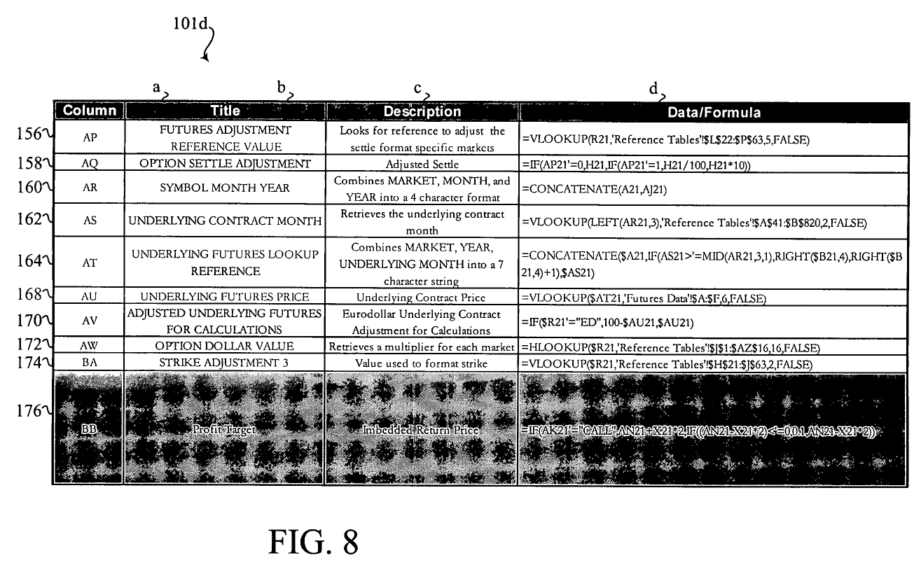

Referring to FIG. 3, the option search page 35 includes a facility to enter the user selectable criteria for an option contract search within a designated market 54. Fill-in windows for budget 36, commission rate 39, and a drop-down window 42 configured to reflect a selection of a term for the option, when used in concert allow rapid searching according to user-designated parameters. Additionally, radio buttons allow designation of the type of option with a “call” button 45a and a “put” button 45b. A “search” button serves as an “execute” command to search the database for options conforming to the designated parameters. Search results are displayed on a results page 104 (FIG. 8) and may be suitably sorted by the user according to several parameters. Upon activating the search button 48a the browser is directed to a results page 51 (FIG. 4) and may be suitably sorted by the user according to several parameters.

Alternative to a selection of a budget by means of the fill-in window 39, a user can search options according to a maximum option premium fill-in window 51. As previously, radio buttons allow designation of the type of option with the “call” button 45a and the “put” button 45b. Again the “search” button serves as an “execute” command to search the database for options conforming to the designated parameters. Again, search results are displayed on the results page 51 (FIG. 4) and may be suitably sorted by the user according to several parameters.

While budget is an effective means of limiting the search results to only those results that the user would be likely to purchase, a user may, alternately, search based upon market direction alone. Such a search may have separate utility in that the user may be searching for a criterion not found on the search page, such as value factor alone, to guide the user's purchasing decision. As before, radio buttons allow designation of the type of option with the “call” button 45a and the “put” button 45b. Again, the “search” button serves as an “execute” command to search the database for options conforming to the designated parameters. Search results are displayed on the results page 51 (FIG. 4) and may be suitably sorted by the user according to several parameters.

Referring to FIG. 4, searches executed at the search page 35 (FIG. 3), yield the results page 51. In the presently preferred embodiment, the results are set forth in a tabular form allowing for display not only of a value factor 82 associated with the contract designator data but also including market 54, market direction 57 (put or call), expiry 60. In the presently preferred embodiment, the most current data recording the price history of the stock is shown in association with the contract. Such data will include both regularly published data in market information sources such as strike price 66, future settle price 69, options settle 72, and the trading volume 84, and data derived from the public data such as open interest 86, premium 75 and intrinsic value 78. Thus, an exemplar contract 95, designates the Canadian Dollar market 54 with a “put” market direction 57 expires in January of 2005. The contract additionally has a unit strike price 66 of 0.82, a future settle price of 0.8369, an options settle price of 0.0580, and an intrinsic value of $0.

By simple counting, the days to expiry 63 are reckoned to be 60 and thus a daily cost 80 is computed at $9.67. A value factor 82 is determined according to Equation 16 yielding an index of 1.791. By activating or deactivating either or both of associated check boxes 90, 93, a user can suitable add the exemplary contract 95 to the monitoring portfolio or active portfolio respectively. Activating a “save” button 99 will execute according to the activation of the monitoring check box 90 or the active check box 93.

Additionally, where a number of the retrieved option contracts such as the exemplar contract 54 are in excess of that number easily displayed on a single page, a “next page” button 87 is used for navigation within the list.

The results page 51 is configured to allow a user to sort findings according to each of the market 54 in which the underlying contract is written, the type of option 105 (“put” or “call”), the expiration date of the option 108, the days to expiration 111, the strike price 114, the futures settle price 117, the options settle 120, the premium 123, the intrinsic value 126, the daily cost 127, and the value factor 102 for the option. The presently preferred embodiment allows great flexibility in displaying the results of the search.

One additional feature is included in the results page 51, a theta warning mechanism. Where a theta value for a put according to equation 21, when divided by the premium 75 exceeds a designated threshold value (in the presently preferred embodiment 1.5%) the lettering that sets forth the contract is suitably red rather than the black lettering used for the contract where the ratio does not exceed 1.5 such as the exemplary contract 95. One such contract 96 is highlighted in this fashion to indicate the theta per premium threshold has been exceeded.

Thus, page 51 is an efficient means of reporting out both the value factor and the relationship theta bears to the premium as well as the other public and derived information relating to the contract. The page 51 may be used by the investor to quickly sort through options or further, finding no options in a market 54 with a market direction 57 that will likely produce a return suitable for investment, the investor may chose to change either market 54 or market direction 57 in order to find contracts with value factors that are much higher than the exemplary contract 95.

While theoretically the value factor 82 for an option contract may range from zero to ten, in fact, value factor 82 falls between 0 and 5. Of the value factors 82 shown on page 51 only four contracts exceed the 1.7, meaning that the remaining contracts are less likely to double the premium as presently configured. As set forth by the results page 51, a savvy investor that still believes that the Canadian Dollar is a worthy market, might well choose to explore a new search on the search page 35 by raising the budget in the fill-in window 36 (FIG. 3) or the drop-down window 42 (FIG. 3) thereby attempting to find stronger positions in the searches as amended.

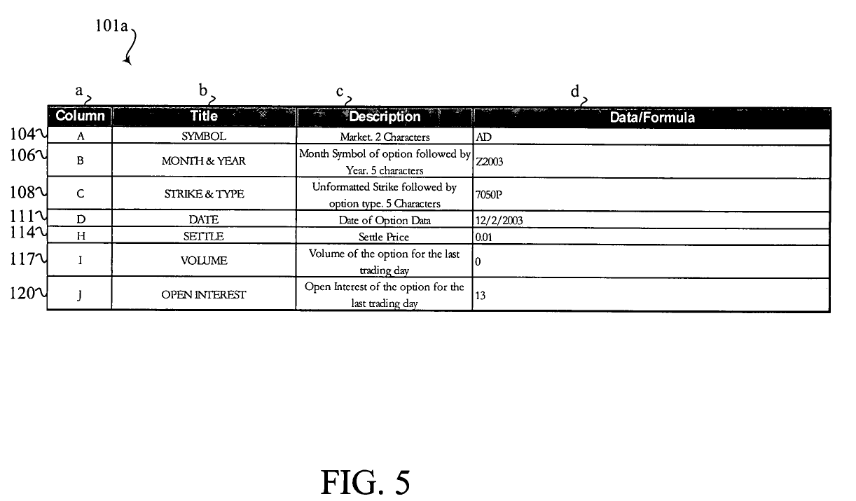

Referring to FIG. 5, a spreadsheet 101a reflects the data import function for importing a single contract into the daily data into a database in order to support a preferred embodiment of the invention. For every variable such as a symbol for a market 104, there exists a column in a database having a heading “A” and a row having a numeric interger ascribed (in this case the integer for this contract is 21). Thus at a cell 104a, the database column “A” is specified. At a cell 104b the plaintext title of the variable or “symbol” is entered to indicate that the column A contains symbols and in this case cell A21 (not shown) of the database has a value “AD” as reported in cell 104d. A description of the variable contained in column A (not shown) is reported in the spreadsheet at cell 104c. Thus, the option market for the cell A21 (not shown) has a market identifier “AD” at a column 21 to describe the market for “Australian Dollar.”

For each identified option contract, information relating to the contract is presented in the spreadsheet for entry in a database. A row 106 reports that column B of the database information for each contract is an expiration date of each option contract as noted in cell 106a. The information in column B is called “Month & Year” (cell 106b) and is noted as a five-symbol code (cell 106c) such that cell B21 contains the text value “Z2003” (cell 106d). The naming convention described in each row of the spreadsheet 101a is the same throughout the spreadsheet 101a.

A row 108 contains information relating to column C “Strike & Type” wherein each contract will be designated by the strike, a four-digit symbol code, followed by P or C to indicate whether the contract is a put or a call option.

A row 111 contains information indicative of the date of entry of the particular price data associated with the contract, each datum must be associated with a date on which the data is valid and is suitably entered in the column D.

By using such a formulaic entry coding system, the database can be configured to allow the appropriate automated entry of data from a service designated from several of the services available. Such data entry includes a settle price for the day is entered at a column H in the database (not shown), as is reported in row 114. Similarly, a row 117 reports a sales volume is suitably entered at a column I. Finally, an open interest of the option for the last trading day is entered at a column J in the database as set forth in the row 120.

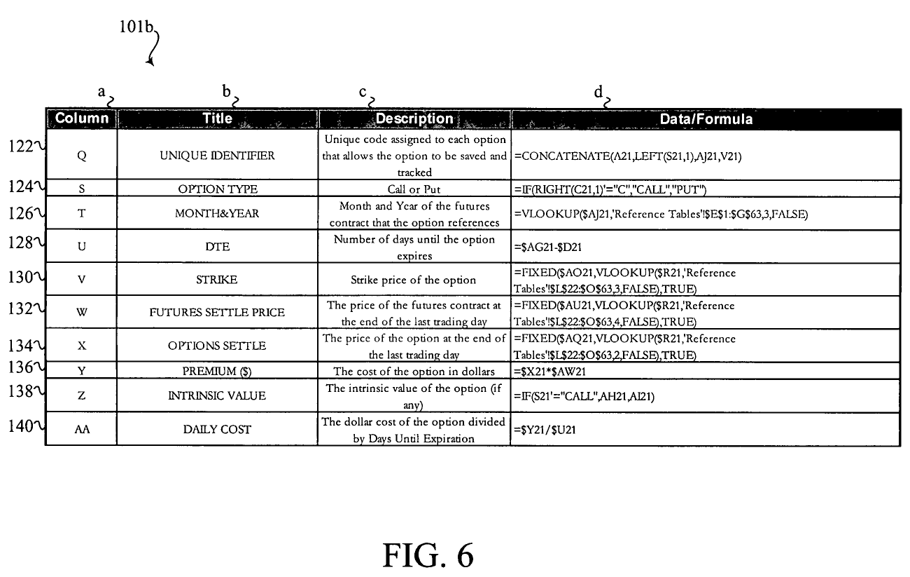

Referring to FIG. 6, the spreadsheet 101b continues at a row 122, indicating that the column Q of the database generates a unique identifier for a contract, that identifier being the concatenation of the market 54 (FIG. 5), the type (put or call), the expiration date of the option, and the strike price of the option. At a row 124, the option type, “put or “call,” is again reflected it was in row 108. At a row 128, the content of column U of the database is defined as “DTE” or days to the expiration of the subject option. Such a DTE is calculated by subtracting the current date from the expiration date.

A column V of the database reported at row 130 checks the strike price of the option as recorded at a column C row 108 (FIG. 5) against a lookup table in order to compute the correct decimal format. A column W of the database reported at a row 132 derives a futures strike price from a lookup table. Similarly, a Column X of the database reported at a row 134 contains an option settle which is the price of the option at the end of the last trading day. Column Y is the premium and is reported at row 136 in dollars. Column Z shows the derived intrinsic value of the option on the date of the data and at a row 138, the intrinsic value is calculated by known means. A daily cost is in column AA of the database and is the dollar cost of the option divided by the DTE in the row 128.

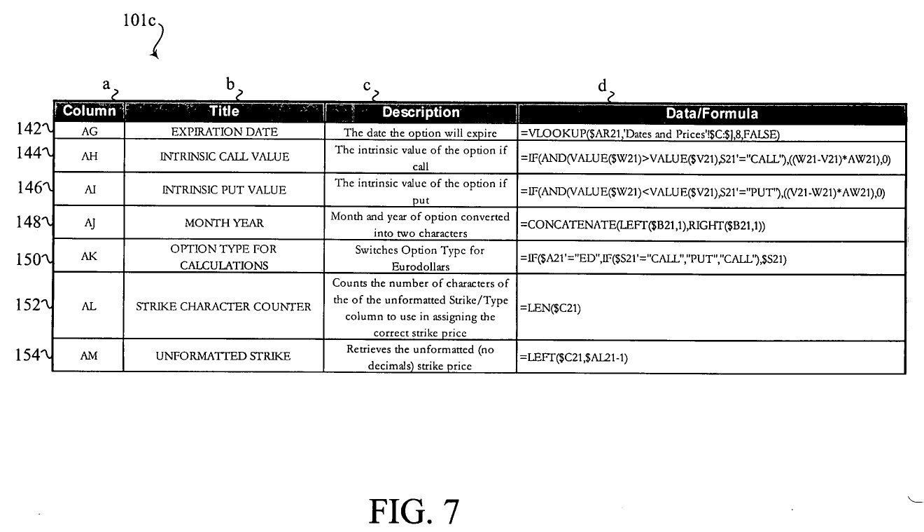

Referring to FIG. 7, a spreadsheet segment 101c includes intermediate data from the entered data, the intermediate data being suitable for developing a value factor. In the row 142, the expiration date is set forth as Column AG and reflects the date the option will expire. At Columns AH and AI of the database, rows 144 and 146 respectively, another conventional calculation is made to determine the intrinsic call and put values. At a Column AJ at s row 148, the month and year of the option are encoded into a two-digit code to aid in association of data. Column AK, at a row 150 of the database is used for conversion to and from Eurodollars; U.S. dollars being the currency of the spreadsheet in the presently preferred embodiment. At a row 152, the variable in Column AK is configured in conjunction with that in a row 154, Column AM to allow collection of strike prices from a subscription source.

Referring to FIG. 8, a spreadsheet segment 101d continues at a row 156 where the Futures Adjustment Reference Value looks for a reference to adjust the settle. At rows 158, 160, 162, 164, 168, 170, 172, and 174, the Column AQ through BA perform housekeeping tasks such as conversions of prices from Eurodollars to US Dollars or looking up reported prices from various sources and homogenizing the results to work together in the spreadsheet in a dollars per contract environment.

At a row 176, the profit target is embedded in the return price to appear in column BB. It is in this column that the equations 18 and 19 are embedded to produce the “bogey” or target returns on the investment known as yield and represented in the equations as “z” according to whether the option is a put or a call:
where z_{Call}=E+2C (18)
and where z_{Put}=E−2P (19)
While the spreadsheet as configured suggests that the constant 2 is “hardwired” into the equation, the 2 is selected as the presently preferred return on the investment. If, for instance, a distinct return might be suitably chosen, if empirical study showed that aiming for a 1.9 unearthed a number of very good opportunities that setting the constant at 2 would miss, the constant will readily be converted to 1.9 in this formula in the spreadsheet without any further modification of the spreadsheet. The row 176 defining column BB in the spreadsheet is the modifiable profit target for enabling the remainder of the spreadsheet.

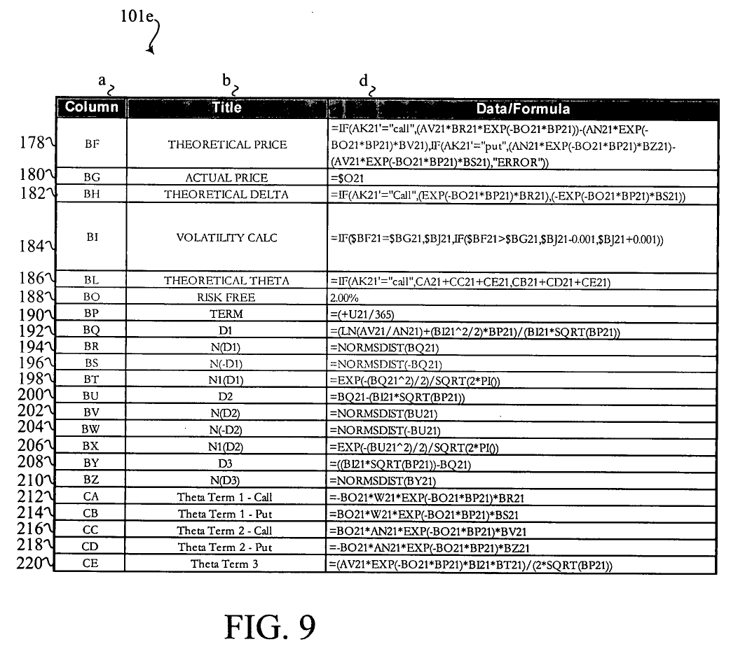

Referring to FIG. 9, the Black-Scholes Model is built out for enablement of the spreadsheet, generating among others the traditional Greek variables from the Black-Scholes Model. A row 178 defines the theoretical price of either a put or a call according either of Equations 13 or 14, whichever is appropriate, based upon the contract type:
C=Ue^{-rt}N(h₁)−Ee^{-rt}N(h₂) (13)
P=Ee^{-rt}N(−h₂)Ue^{-rt}N(−h₁) (14)
Thus, theoretical price is set forth in database column BF.

At a row 180, an actual price is downloaded from the “newspaper data” and populates the BG column in the database. A theoretical delta in a row 182 from the traditional Black-Scholes Model is included solely as an example of the calculation of each of the “Greeks.” As indicated above, the results page 51 (FIG. 4) is optionally configurable to add such other variables that might guide the investor would be expressed in the tabular results of the search. The value factor 84 is but one tool to understand the investment decision but that decision need not be made without the benefit of other available tools.

A by-product of using the Black-Scholes Model is the calculation of the delta: the degree to which an option price will move given a small change in the underlying option contract exercise price. For example, an option with a delta of 0.5 will move half a cent for every full cent movement in the underlying contract. A deeply out-of-the-money call will have a delta very close to zero; an at-the-money call of 0.5; and a deeply in-the-money call will have a delta very close to 1. At a column BH in the database, a theoretical delta is derived from the “newspaper data.”

Volatility is calculated as in Equation (11) to populate column BI at a row 18. In simple terms, volatility is a measure of the degree of movement of the underlying security. Volatility does not show the direction of this movement, only the degree to which the stock tends to move. Volatility is an important input in the Black-Scholes option-pricing model. Volatility is calculated using the standard deviation of option contract prices.

At a column BL in the database shown at row 186, a theoretical theta is. determined in accord with either of Equations (20) or (21) according to whether the theta is being calculated according to the type of option, call or put respectively. As set for the above, theta is a measure of time decay.

At a column BO of the database, reported at a row 188 is populated by another piece of newspaper data, the interest rate of a risk-free investment such as US treasury bills.

At a row 190 or column BP of the database, an arithmetic calculation converting the term of the option contract from days to years or fractions of years occurs.

At a row 192 or column BQ of the database, a traditionally identified as h₁ is calculated according to the Equation (9) and identified as D1 in the spreadsheet. Once the column BQ of the database is populated with a value for h₁, N(h₁) is readily calculable with the NORMDIST function of the spreadsheet. Thus, at a row 194, in column BR of the database, by using a normal distribution function, a value for h₁ is calculated. Similarly at a row 198, the normal distribution of the inverse value is calculated as N(−h₁). Thus at a row 196 is also readily calculated from the value of h₁ with the normal distribution function at a column BS. N`(h₁), at a row 198, is calculated the statistical equation set forth at column BT in the database.

A similar series of normal distributions is calculated variable, traditionally identified as h₂ is calculated according to the Equation (9) and identified as D2 in the spreadsheet. N(h₂) in a row 202, N(−h₁) in a row 196, and N`(h₂) in a row 206. At a row 208, an h₃ is calculated to enable deriving of some of the “Greeks” and the normal distribution of h₃, N(h₃) at a row 210.

Because theta for either puts or calls is based upon a normalized distribution of the series of normalized distributions set forth at rows 192 through 206, and because each is expressed differently in each of Equations 20 and 21, it is necessary to break down the terms into three terms, a first term, a second term, and a third term

$$\frac{U {ⅇ}^{- rt} {N}^{′} ( {h}_{1} )}{2 \sqrt{t}}$$

in common between the two equations:

$$\begin{matrix}{θ}_{call} = - rU {ⅇ}^{- rt} N ( {h}_{1} ) + rE {ⅇ}^{- rt} N ( {h}_{2} ) + \frac{U {ⅇ}^{- rt} {N}^{′} ( {h}_{1} )}{2 \sqrt{t}} & ( 20 ) \\ {θ}_{put} = rU {ⅇ}^{- rt} N ( - {h}_{1} ) - rE {ⅇ}^{- rt} N ( - {h}_{2} ) + \frac{U {ⅇ}^{- rt} {N}^{′} ( {h}_{1} )}{2 \sqrt{t}} & ( 21 )\end{matrix}$$

At a row 212, the first theta call term, −rUe^{-rt}N(h₁), is calculated. At a row 212 the first theta put term, rUe^{-rt}N(−h₁), is likewise calculated. Similarly, the second theta call term, rEe^{-rt}N(h₂), is calculated at a row 216. And, the second theta put term, rEe^{-rt}N(−h₂), is calculated at a row 218. The third theta term in common,

$$\frac{U {ⅇ}^{- rt} {N}^{′} ( {h}_{1} )}{2 \sqrt{t}} ,$$

is calculated at a row 220.

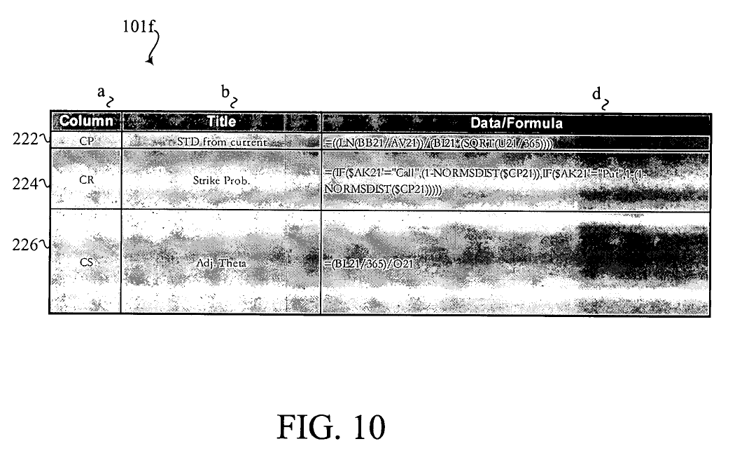

Referring to FIG. 10, a spreadsheet segment 101g continues to finally enable both the value factor and the theta warning. At a row 222, column CP in the database, a value for

$$q = \frac{ln ( \frac{z}{U} )}{v \sqrt{t}}$$

is derived. A strike probability equal to one tenth of the Value Factor 84 (FIG. 4) is calculated according to either of Equations 15 or 16 and based upon the result in the row 222 and is reported at a row 224. If the calculated strike probability at the space CR is a value less than zero, a zero is substituted as the reported strike probability at a space CQ, otherwise, the value at CR is repeated at space CQ.

An adjusted theta is calculated from the theta and reported at a row 226 and differs from a traditional Black-Scholes Model by normalizing theta to reflect a daily decay value, and dividing this adjusted theta value into the current premium. As with the option contract 96, this value is compared to a configurable value, currently in the preferred embodiment 1.5% in all markets. In the presently preferred embodiment, a legend describing the option is highlighted in red where the value reported in the row 226 exceeds the configurable value in order to indicate a rapid acceleration in time decay.

While preferred embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for computing a value factor of at-least-one option contract having a market, an expiration date, a price of an underlying contract on a current date, a strike price, the method comprising:
calculating a theoretical return based upon the expiration date, the strike price, the price of the underlying contract on the current date, and a risk-free interest rate on the current date;
targeting a yield (z) based upon the price of the underlying contract and a designated multiple of the theoretical return of the at-least-one option contract; and
calculating the value factor based upon the yield (z), an underlying contract price, and the expiration date.

2. The method of claim 1, the method further comprising:
calculating an annual volatility that is a standard deviation of the price of the underlying contract; and
basing the calculating of the value factor upon the volatility.

3. The method of claim 1, wherein the volatility is a standard deviation of variance of a price of the at-least-one financial option.

4. The method of claim 3, wherein the variance of the price is measured over a period of one year.

5. The method of claim 1, wherein the calculating the value factor further comprises:
determining if the at-least-one option contract is a put; and
subtracting the designated multiple of the theoretical return from the price of the underlying contract to determine the value factor if the at-least-one option contract is a put.

6. The method of claim 1, wherein the calculating the value factor further comprises:
determining if the at-least-one option contract is a call; and
adding the designated multiple of the theoretical return from the price of the underlying contract to determine the value factor if the at-least-one option contract is a call.

7. The method of claim 1, wherein the theoretical value of the at-least-one option contract is further based upon a change in the premium with respect to a change in the underlying contract price.

8. The method of claim 6, wherein the theoretical value of the at-least-one option contract is further based upon a present value of paying the exercise price on the expiration day.

9. The method of claim 1, wherein the designated multiple is selected according to the market of the option contract.

10. The method of claim 1, wherein the designated multiple is twice the theoretical value.

11. The method of claim 1, further comprising:
sorting a table containing the at-least-one option contract according to the value factor.

12. The method of claim 11, further comprising:
deriving a daily value for theta;
dividing the value for theta by a premium associated with the at-least-one option contract to generate an adjusted theta value associated with the at-least-one option contract.

13. The method of claim 12, further comprising:
comparing the adjusted theta value to a designated threshold value.

14. The method of claim 13, further comprising:
generating an alert where the theta value exceeds the designated threshold value.

15. The method of claim 13, further comprising:
generating an alert where the designated threshold value exceeds the theta value.

16. The method of claim 13 wherein the threshold value is designated according to the market.

17. The method of claim 13, wherein the threshold is 1.5%.

18. The method of claim 11, further comprising:
sorting the at-least-one option contract according to the adjusted theta value.

19. The method of claim 11, further comprising:
deriving at least one of the “Greek” values according the Black-Scholes Model, the “Greek” values associated with at-least-one option contract being selected from a group that includes theta, delta, gamma, rho, and vega.

20. The method of claim 19 further comprising:
including the at-least-one of the “Greek” values in the table and associated with the at-least-one option contract.

21. A method for deriving an adjusted theta value associated with at-least-one option contract having an expiration date, a price of an underlying contract on a current date, a strike price, the method comprising:
deriving a theta value for the at-least-one option contract based upon the expiration date, the price of an underlying contract on the current date, the strike price and a rate for risk free investment;
normalizing the theta value from an annual to a daily value; and
dividing the theta value by a premium to generate an adjusted theta value.

22. The method of claim 21, wherein the deriving a theta value includes:
determining if the option contract is a put; and
deriving theta according to a put theta formula.

23. The method of claim 21, wherein the deriving a theta value includes:
determining if the option contract is a call; and
deriving theta according to a call theta formula.

24. The method of claim 21, further comprising:
comparing the adjusted theta value to a designated threshold value.

25. The method of claim 24, further comprising:
generating an alert associated with the at-least-one option contract when the theta value exceeds the designated threshold value.

26. The method of claim 24, further comprising:
generating an alert associated with the at-least-one option contract when the designated threshold value exceeds the theta value.

27. The method of claim 24, wherein:
determining the designated threshold value according to a market associated with the at-least-one option contract.

28. The method of claim 24, further comprising:
associating a value factor with the at-least-one option contract.

29. The method of claim 28, further comprising:
tabulating the at-least-one option contract in a table in association with the adjusted theta and the value factor.

30. The method of claim 29, further comprising:
sorting the at-least-one option contract according to a magnitude of the value factor.

31. A computer software program stored on a machine readable medium, the program configured to compute a value factor of at-least-one option contract having a market, an expiration date, a price of an underlying contract on a current date, a strike price, the software program comprising:
a first script configured to calculate a theoretical return based upon the expiration date, the strike price, the price of the underlying contract on the current date, and a risk-free interest rate on the current date;
a second script configured to targeting a yield (z) based upon the price of the underlying contract and a designated multiple of the theoretical return of the at-least-one option contract; and
a third script configured to calculate the value factor based upon the yield (z), an underlying contract price, and the expiration date.

32. The software program of claim 31, the software program further comprising:
a fourth script configured to calculate an annual volatility that is a standard deviation of the price of the underlying contract; and
the third script further configured to base the calculating of the value factor upon the volatility.

33. The software program of claim 31, wherein the volatility is a standard deviation of variance of a price of the at-least-one financial option.

34. The software program of claim 33, wherein the variance of the price is measured over a period of one year.

35. The software program of claim 31, wherein the third script is further configured to:
determine if the at-least-one option contract is a put; and
subtract the designated multiple of the theoretical return from the price of the underlying contract to determine the value factor if the option contract is a put.

36. The software program of claim 31, wherein the third script is further configured to:
determine if the at-least-one option contract is a call; and
add the designated multiple of the theoretical return from the price of the underlying contract to determine the value factor if the option contract is a call.

37. The software program of claim 31, wherein the theoretical value of the at-least-one option contract is further based upon a change in the premium with respect to a change in the underlying contract price.

38. The software program of claim 36, wherein the theoretical value of the at-least-one option contract is further based upon a present value of paying the exercise price on the expiration day.

39. The software program of claim 31, wherein the designated multiple is selected according to the market of the option contract.

40. The software program of claim 31, wherein the designated multiple is twice the theoretical value.

41. The software program of claim 31, further comprising:
a fifth script configured to sort a table containing the at-least-one option contract according to the value factor.

42. The software program of claim 41, further comprising:
a sixth script configured to derive a daily value for theta;
a seventh script configured to divide the value for theta by a premium associated with the option contract to generate an adjusted theta value associated with the at-least-one option contract.

43. The software program of claim 42, further comprising:
an eighth script configured to compare the adjusted theta value to a designated threshold value.

44. The software program of claim 43, further comprising:
a ninth script configured to generate an alert where the theta value exceeds the designated threshold value.

45. The software program of claim 43, further comprising:
a ninth script configured to generate an alert where the designated threshold value exceeds the theta value.

46. The software program of claim 43 wherein the threshold value is designated according to the market.

47. The software program of claim 43, wherein the threshold is 1.5%.

48. The software program of claim 41, further comprising:
a tenth script configured to sort the at-least-one option contract according to the adjusted theta value.

49. The software program of claim 41, further comprising:
an eleventh script configured to derive at least one of the “Greek” values according the Black-Scholes Model, the “Greek” values associated with at-least-one option contract being selected from a group that includes theta, delta, gamma, rho, and vega.

50. The software program of claim 49 further comprising:
a twelfth script configured to include the at-least-one of the “Greek” values in the table and associated with the at-least-one option contract.

51. A computer software program stored on a machine readable medium, the program configured to derive an adjusted theta value associated with at-least-one option contract having an expiration date, a price of an underlying contract on a current date, a strike price, the method comprising:
a first script configured to derive a theta value for the at-least-one option contract based upon the expiration date, the price of an underlying contract on the current date, the strike price and a rate for risk-free investment;
a second script configured to normalize the theta value from an annual to a daily value; and
a third script configured to divide the theta value by a premium to generate an adjusted theta value.

52. The software program of claim 51, wherein the first script includes:
a fourth script configured to determine if the option contract is a put; and
a fifth script configured to derive theta according to a put theta formula if the fourth script is a put.

53. The software program of claim 51, wherein the first script includes:
a fourth script configured to determine if the option contract is a call; and
a fifth script configured to derive theta according to a call-theta formula if the fourth script is a call.

54. The software program of claim 51, further comprising:
a sixth script configured to compare the adjusted theta value to a designated threshold value.

55. The software program of claim 54, further comprising:
a seventh script configured to generate an alert associated with the at-least-one option contract when the theta value exceeds the designated threshold value.

56. The software program of claim 54, further comprising:
a seventh script configured to generate an alert associated with the at-least-one option contract when the designated threshold value exceeds the theta value.

57. The software program of claim 54, wherein:
an eighth script configured to determine the designated threshold value according to a market associated with the at-least-one option contract.

58. The software program of claim 54, further comprising:
a ninth script configure to associate a value factor with the at-least-one option contract.

59. The software program of claim 58, further comprising:
a tenth script configured to tabulate the at-least-one option contract in a table in association with the adjusted theta and the value factor.

60. The software program of claim 59, further comprising:
an eleventh script configured to sort the at-least-one option contract according to a magnitude of the value factor.

61. A method to assist in selecting an option contract for investment, the method comprising:
calculating a theoretical return for a plurality of option contracts based upon attributes of each option contract, the attributes including an expiration date, a strike price, a price of the underlying contract on a current date, and a risk-free interest rate on the current date;
designating a yield (z) for each option contract based upon the price of the underlying contract associated with the option contract and a designated multiple of the theoretical return of the at-least-one option contract; and
calculating a value factor of each option contract based upon the yield (z), an underlying contract price, the expiration date associated with that option contract.

62. The method of claim 61, further comprising:
grouping the plurality of option contracts according to a market associated with each of the option contracts to form at least one set of option contracts, the at-least-one set configured to contain only option contracts from a designated market.

63. The method of claim 62, further comprising:
receiving a user inquiry associated with the at-least-one set of option contracts, the user inquiry including attributes selected from a group consisting of budget, time horizon, and market direction;
grouping the option contracts in the at-least-one set of option contracts into a responsive set, the responsive set containing option contracts implicated by the user inquiry; and
displaying information associated with option contracts in the responsive set, the information including the value factor.

64. The method of claim 63, wherein the displaying information associated with option contracts is displaying in tabular form.

65. The method of claim 63, wherein the information associated with option contracts in the responsive set includes at least one of the “Greek” values according the Black-Scholes Model, the “Greek” values associated with at-least-one option contract being selected from a group that includes theta, delta, gamma, rho, and vega.

66. The method of claim 65, wherein theta includes an adjusted theta.

67. The method of claim 66, wherein displaying theta comprises:
generating an alert when theta exceeds a designated threshold value.

68. The method of claim 67, wherein:
the designated threshold value is determined according to the market.

69. The method of claim 66, wherein displaying theta:
comprises generating an alert when a designated threshold value exceeds theta.

70. The method of claim 69, wherein:
the designated threshold value is determined according to the market.

71. A computer software program stored on a machine readable medium, the software program configured to aid an investor in selecting an option contract for investment, the method comprising:
a first script configured to calculate a theoretical return for a plurality of option contracts based upon attributes of each option contract, the attributes including an expiration date, a strike price, a price of the underlying contract on a current date, and a risk-free interest rate on the current date;
a second script configured to designate a yield (z) for each option contract based upon the price of the underlying contract associated with the option contract and a designated multiple of the theoretical return of the at-least-one option contract; and
a third script configured to calculate a value factor of each option contract based upon the yield (z), an underlying contract price, the expiration date associated with that option contract.

72. The software program of claim 71, further comprising:
a fourth script configured to group the plurality of option contracts according to a market associated with each of the option contracts to form at-least-one set of option contracts, the at-least-one set configured to contain only option contracts from a designated market.

73. The software program of claim 72, further comprising:
a fifth script configured to receive a user inquiry associated with the at-least-one set of option contracts, the user inquiry including attributes selected from a group consisting of budget, time horizon, and market direction;
a sixth script configured to group option contracts in the at-least-one set of option contracts into a responsive set, the responsive set containing option contracts implicated by the user inquiry; and
a seventh script configured to display information associated with option contracts in the responsive set, the information including the value factor.

74. The software program of claim 73, wherein the displaying information associated with option contracts is displaying in tabular form.

75. The software program of claim 73, wherein the information associated with option contracts in the responsive set includes at least one of the “Greek” values according the Black-Scholes Model, the “Greek” values associated with at-least-one option contract being selected from a group that includes theta, delta, gamma, rho, and vega.

76. The software program of claim 75, wherein theta includes an adjusted theta.

77. The software program of claim 76, wherein the seventh script comprises:
an eighth script configured to generate an alert when theta exceeds a designated threshold value.

78. The software program of claim 77, wherein:
the designated threshold value is determined according to the market.

79. The software program of claim 76, wherein the seventh script comprises:
comprises an eighth script configured to generate an alert when a designated threshold value exceeds theta.

80. The software program of claim 79, wherein:
the designated threshold value is determined according to the market.
